(19) United States
(12) Patent Application Publication
(10) Pub. No.: US 2023/0367937 A1
(43) Pub. Date: Nov. 16, 2023

(54) System and Method for Generating Device Model Parameter

(71) Applicant: GoEdge.ai, Hsinchu City (TW)

(72) Inventors: Chao-Quan You, Taoyuan City (TW); Chien-Chih Chen, Hsinchu City (TW); Yu-Ming Chang, Chiayi City (TW); Tien-Fu Chen, Hsinchu County (TW); Hao-Pin Wu, Hsinchu City (TW)

(73) Assignee: GoEdge.ai, Hsinchu City (TW)

(21) Appl. No.: 17/859,008

(22) Filed: Jul. 7, 2022

(30) Foreign Application Priority Data
May 10, 2022 (TW) 111117494

(51) Int. Cl. G06F 30/3308

(52) U.S. Cl. CPC G06F 30/3308; G06F 2111/06

(57) ABSTRACT

A device model parameter generation system, comprises a user module, for obtaining parameter set configurations and measurement data of devices; a parameter extraction module, for performing parameter extractions on the parameter set configurations and the measurement data, to generate a parameter set; a simulation module, for performing simulations according to the parameter set configurations and the measurement data, to generate a simulation results; an analysis module, for determining whether the devices conform to a trend according to the parameter set, to generate a first determination result, and for determining whether the devices conform to a smoothness according to the first determination result and the parameter set, to generate a second determination result; and a device model parameter generation module, for generating a device model parameters according to the second determination result and the parameter set.

### BACKGROUND OF THE INVENTION

### 1. Field of the Invention

The present invention relates to a system and a method for generating device model parameters.

### 2. Description of the Prior Art

As the complexity of circuits increases (e.g., the number or density of electronic devices increases) and the computing capability of computers improves simultaneously, simulating characteristics (e.g., capability, performance) of circuits by computers has become a common approach in the field of circuit design/manufacturing. Generally, a computer may store (e.g., install) a circuit simulation software, which may include multiple default device models. The circuit simulation software may generate simulation results representing the characteristics of the target device based on the equations of the selected device model and the model parameters set by a user.

Despite being assisted by computers, the common approach to model the given electronic devices are far from optimal in the field of the circuit design/manufacturing. To model a single device, an engineer have to repeatedly and manually adjust the model parameters according to her/his own knowledge and experience until a fitting model is generated. Such an approach lacks efficiency and reliability, as it is based only on subjective judgments and recurrent operations of the engineer. In addition, this procedure considers only the target device; the relation between the target device and the adjacent devices is ignored. As the result, the obtained model very often lacks consistency and is difficult to meet the industrial standard. Thus, improving the procedure of device modeling, especially finding a more efficient and reliable approach to generating device model parameters, remains an important problem to be solved.

### SUMMARY OF THE INVENTION

The present invention therefore provides a system and a method for generating device model parameters to solve the aforementioned problem.

A device model parameter generation system, comprises a user module, for obtaining a plurality of parameter set configurations and a plurality of measurement data of a plurality of devices; a parameter extraction module, coupled to the user module, for performing a plurality of parameter extractions on the plurality of parameter set configurations and the plurality of measurement data, to generate a parameter set; a simulation module, coupled to the parameter extraction module, for performing a plurality of simulations according to the plurality of parameter set configurations and the plurality of measurement data, to generate a plurality of simulation results; an analysis module, coupled to the parameter extraction module, for determining whether the plurality of devices conform to a trend according to the parameter set, to generate a first determination result, and for determining whether the plurality of devices conform to a smoothness according to the first determination result and the parameter set, to generate a second determination result; and a device model parameter generation module, coupled to the analysis module, for generating a plurality of device model parameters according to the second determination result and the parameter set.

A method of generating a device model parameter, comprises: obtaining a plurality of parameter set configurations and a plurality of measurement data of a plurality of devices; performing a plurality of parameter extractions on the plurality of parameter set configurations and the plurality of measurement data, to generate a parameter set; performing a plurality of simulations according to the plurality of parameter set configurations and the plurality of measurement data, to generate a plurality of simulation results; determining whether the plurality of devices conform to a trend according to the parameter set, to generate a first determination result, and for determining whether the plurality of devices conform to a smoothness according to the first determination result and the parameter set, to generate a second determination result; and generating a plurality of device model parameters according to the second determination result and the parameter set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an IC industry chain according to an example of the present invention.

FIG. 2 is a schematic diagram of a device model parameter generation system according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

### DETAILED DESCRIPTION

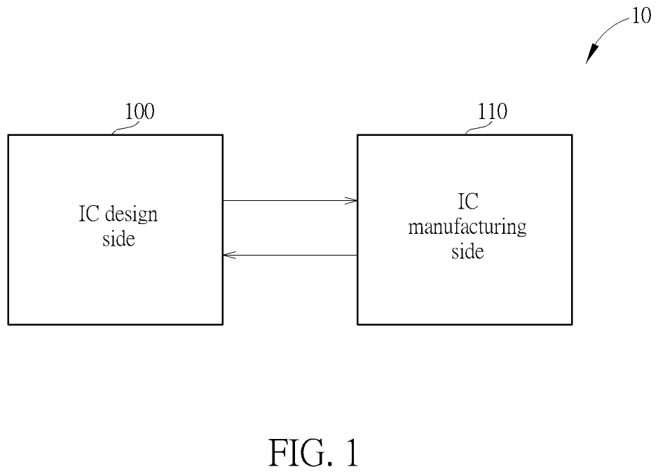

FIG. 1 is a schematic diagram of an integrated circuit (IC) industry chain 10 according to an example of the present invention. The IC industry chain 10 may be briefly composed of an IC design side 100 and an IC manufacturing side 110. In FIG. 1, the IC design side 100 and the IC manufacturing side 110 are simply utilized for illustrating a structure of the IC industry chain 10. Practically, the IC design side 100 may provide IC design layout to the IC manufacturing side 110. According to the IC design layout provided by the IC design side 100, the IC manufacturing side 110 may generate device model parameters (also termed as device model cards), and may provide the device model parameters to the IC design side 100. According to the device model parameters provided by the IC manufacturing side 110, the IC design side 100 may process (e.g., simulation test, analyze, modify, or complete) the IC design layout, to obtain the IC design layout which can be rolled out (i.e., produced at a production line). In one example, the IC design side 100 may include a fabless. In one example, the IC manufacturing side 110 may include a foundry.

In one example, the IC manufacturing side 110 generates the device model parameters, which may include the following operations: (1) trying to produce electronic devices (e.g., transistors) with the same type and different sizes; (2) measuring electrical property (e.g., currents at different voltages) of the electronic devices with various sizes, to generate measurement results; (3) for the electronic devices with different sizes, repeatedly adjusting (e.g., manually adjusting according to an engineer's knowledge and experiences) the device model parameters, to generate optimal device model parameters which meet the measurement results; (4) generating a (e.g., generalized) device model which can accurately describe electronic devices with the same type and all sizes according to the optimal device model parameters of the electronic devices with the different sizes (e.g., generating device model parameters for an electronic device with a specific (e.g., target) size according to an interpolation operation).

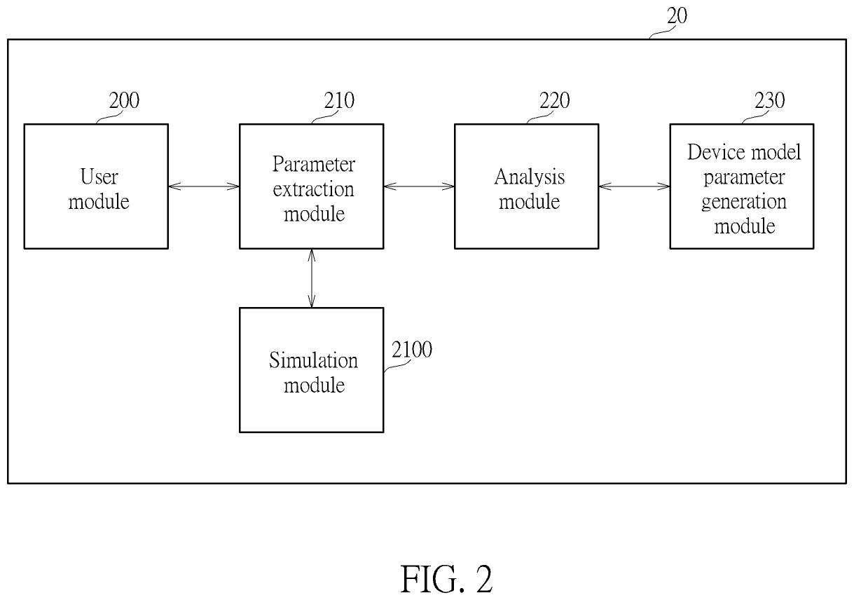

FIG. 2 is a schematic diagram of a device model parameter generation system 20 according to an example of the present invention, and may be used for realizing the IC manufacturing side 110 in FIG. 1, for generating device model parameters. As shown in FIG. 2, the device model parameter generation system 20 may include a user module 200, a parameter extraction module 210, an analysis module 220 and a device model parameter generation module 230. The user module 200 may be for obtaining (e.g., loading) a plurality of parameter set configurations and a plurality of measurement data of a plurality of devices. The parameter extraction module 210 may be coupled to (e.g., connect to) the user module 200, and may be for performing a plurality of parameter extractions on the plurality of parameter set configurations and the plurality of measurement data, to generate a parameter set. The analysis module 220 may be coupled to the parameter extraction module 210, and may be for determining whether the plurality of devices conform to a trend (e.g., trending up or down) according to the parameter set, to generate a first determination result, and may be for determining whether the plurality of devices conform to a smoothness (e.g., level) according to the first determination result and the parameter set, to generate a second determination result. The device model parameter generation module 230 may be coupled to the analysis module 220, and may be for generating (e.g., outputting) a plurality of device model parameters according to the second determination result and the parameter set. That is, the device model parameter generation system 20 generates the plurality of device model parameters by taking into account the trend and the smoothness of the plurality of devices.

As shown in FIG. 2, the device model parameter generation system 20 may include a simulation module 2100. The simulation module 2100 may be coupled to the parameter extraction module 210, or may be include in the parameter extraction module 210 (not illustrated in FIG. 2). The simulation module 2100 may be for performing a plurality of simulations according to the plurality of parameter set configurations and the plurality of measurement data, to generate a plurality of simulation results. In one example, the simulation module 2100 may include (e.g., store or install) a simulation software for simulating devices, e.g., simulation program with IC emphasis (SPICE). In one example, the simulation software may include various default device models, e.g., Berkeley short-channel insulated-gate field effect transistor model (BSIM), derived device models (e.g., BSIM2 or BSIM3 or BSIM4) or other suitable device models, but is not limited herein. In detail, in the simulation software, the simulation module 2100 may simulate characteristics (e.g., capability, performance) of a device via setting (e.g., input) parameter set configurations to a device model, and may generate a simulation result. In one example, the simulation result may include correspondences between the characteristics of the device (e.g., threshold voltage (vth), ion at linear mode (idlin), ion at saturation mode (idsat), ioff at saturation mode (iofn) or other electrical properties, but is not limited herein), e.g., a correspondence between different vths corresponding to different idlins, but is not limited herein.

In one example, each parameter set configuration of the plurality of parameter set configurations may include values set (e.g., manually) according to the characteristics of the device. In one example, each measurement data of the plurality of measurement data may include a length and a width of the device.

In one example, the parameter extraction module 210 performs the plurality of parameter extractions on the plurality of parameter set configurations and the plurality of measurement data, which may include the following operations: (A) generating a plurality of candidate parameter sets according to a parameter set configuration in the plurality of parameter set configurations and a measurement data in the plurality of measurement data. (B) providing (e.g., transmitting) the plurality of candidate parameter sets to the simulation module 2100, and obtaining (e.g., from the simulation module 2100) the plurality of simulation results. (C) selecting a plurality of parameter sets from the plurality of candidate parameter sets according to the plurality of simulation results. (D) determining whether the plurality of parameter sets meet a termination criterion, to generate a third determination result. (E) generating (e.g., outputting) the plurality of parameter sets according to the third determination result.

In one example, the parameter extraction module 210 performs the plurality of parameter extractions on the plurality of parameter set configurations and the plurality of measurement data, which may further include the following operations: performing an interpolation operation on the plurality of parameter sets according to an interpolation equation, to generate coefficients, and generating a parameter set (e.g., of a virtual device) according to the coefficients. In one example, the interpolation equation may be realized according to the equation (Eq. 1):

P(L,W)ᵢ=Pᵢ+PLᵢ/L_{eff}+PWᵢ/W_{eff}+PPᵢ/(W_{eff}L_{eff}) (Eq. 1)
wherein Pᵢ are constant model parameters in the ith bin (in the plurality of parameter sets). PLᵢ are length-depended model parameters in the ith bin (in the plurality of parameter sets). PWᵢ are width-depended model parameters in the ith bin (in the plurality of parameter sets). PPᵢ are length-width-depended model parameters in the ith bin (in the plurality of parameter sets). L_{eff} is an effective gate length. W_{eff} is an effective gate width. i is a positive integer (e.g., 1, 2, 3 or 4). In one example, the coefficients may be realized according to Pᵢ, PLᵢ, PWᵢ and PPᵢ in the equation (Eq. 1).

In one example, the parameter extraction module 210 may generate (e.g., output) the plurality of parameter sets according to the plurality of parameter sets, when the third determination result indicates that the plurality of parameter sets meet the termination condition. In one example, the parameter extraction module 210 may perform a genetic algorithm on the plurality of parameter sets to generate (e.g., update) the plurality of parameter sets (i.e., regards the updated plurality of parameter sets as the plurality of candidate parameter sets) and returns to the operation (B) (e.g., until the third determination result indicates that the plurality of parameter sets meet the termination condition), when the third determination result indicates that the plurality of parameter sets do not meet the termination condition. In one example, the termination condition may include a correspondence level (e.g., reaching a default correspondence score or percentage) of the simulation results generated according to the plurality of parameter sets and their corresponding (e.g., fit) devices. In one example, the termination condition may include a default number of times (e.g., N times, wherein N is a positive integer). In one example, the genetic algorithm may include a crossover operation, a mutation operation, other genetic algorithms suitable for the genetic variation or combinations thereof, but is not limited herein. In one example, at least one parameter in any two parameter sets of the plurality of parameter sets (e.g., the first M parameters in the any two parameter sets, where M is a positive integer) can be interchanged according to the crossover operation. In one example, each parameter set of the plurality of parameter sets may be perturbed according to the mutation operation.

In one example, the analysis module 220 (e.g., further) determines whether the plurality of devices conform to the smoothness to generate the second determination result, when the first determination result indicates that the plurality of devices conform to the trend. In one example, the device model parameter generation module 230 generates the plurality of device model parameters according to the parameter set, when the second determination result indicates that the plurality of devices conform to the smoothness. In one example, the analysis module 220 returns to the parameter extraction module 210 and the parameter extraction module 210 performs the plurality of parameter extractions on the plurality of parameter set configurations and the plurality of measurement data (e.g., until the second determination result indicates that the plurality of devices conform to the smoothness), when the second determination result indicates that the plurality of devices do not conform to the smoothness.

In one example, the analysis module 220 returns to the parameter extraction module 210 and the parameter extraction module 210 performs the plurality of parameter extractions on the plurality of parameter set configurations and the plurality of measurement data (e.g., until the first determination result indicates that the plurality of devices conform to the trend), when the first determination result indicates that the plurality of devices do not conform to the trend.

In one example, the analysis module 220 determines whether the plurality of devices conform to the trend to generate the first determination result, which may include the following operations: generating a first slope according to the plurality of measurement data, and generating the trend according to the first slope. For example, the trend is up when the first slope is positive. The trend is down when the first slope is negative. In addition, the analysis module 220 generates a second slope according to (e.g., characteristics of) the plurality of devices corresponding to (e.g., fitted by) the plurality of simulation results, and comparing the second slope with the first slope (e.g., whether the signs are the same) to generate a first comparison result. The analysis module 220 generates the first determination result according to the first comparison result. For example, the analysis module 220 determines that the plurality of devices conform to the trend and the first determination result indicates that the plurality of devices conform to the trend, when the first comparison result indicates that the signs of the second slope and the first slope are the same (e.g., both are positive or both are negative). The analysis module 220 determines that the plurality of devices do not conform to the trend and the first determination result indicates that the plurality of devices do not conform to the trend, when the first comparison result indicates that the signs of the second slope and the first slope are different (e.g., one is positive and another is negative).

In one example, the analysis module 220 determines whether the plurality of devices conform to the smoothness to generate the second determination result, which may include the following operations: performing an interpolation operation on (e.g., the characteristics of) the plurality of devices to generate a plurality of virtual devices, and generating a plurality of third slopes according to the plurality of virtual devices. The analysis module 220 compares the plurality of third slopes with the first slope (e.g., whether the signs are the same) to generate a plurality of second comparison results. The analysis module 220 determines whether the plurality of devices conform to the smoothness according to the plurality of second comparison results, to generate the second determination result. For example, the analysis module 220 determines that the plurality of devices conform to the smoothness and the second determination result indicates that the plurality of devices conform to the smoothness, when the second comparison result indicates that the signs of the plurality of third slopes and the first slope are all the same (e.g., both the former and the latter are positive or are negative). The analysis module 220 determines that the plurality of devices do not conform to the smoothness and the second determination result indicates that the plurality of devices do not conform to the smoothness, when the second comparison result indicates that the signs of one of the plurality of third slopes and the first slope are different (e.g., one is positive and another is negative).

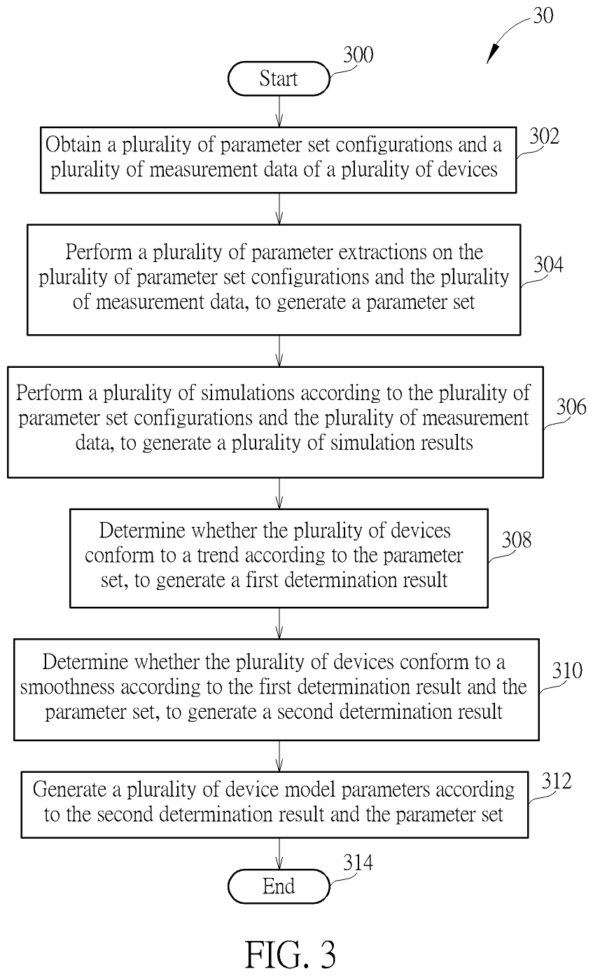

Operations of the device model parameter generation system 20 in the above examples may be summarized into a process 30 shown in FIG. 3. The process 30 may include the following steps:
Step 300: Start.
Step 302: Obtain a plurality of parameter set configurations and a plurality of measurement data of a plurality of devices.
Step 304: Perform a plurality of parameter extractions on the plurality of parameter set configurations and the plurality of measurement data, to generate a parameter set.
Step 306: Perform a plurality of simulations according to the plurality of parameter set configurations and the plurality of measurement data, to generate a plurality of simulation results.
Step 308: Determine whether the plurality of devices conform to a trend according to the parameter set, to generate a first determination result.
Step 310: Determine whether the plurality of devices conform to a smoothness according to the first determination result and the parameter set, to generate a second determination result.
Step 312: Generate a plurality of device model parameters according to the second determination result and the parameter set.
Step 314: End.

In one example, the order of Step 308 and Step 310 may be exchanged.

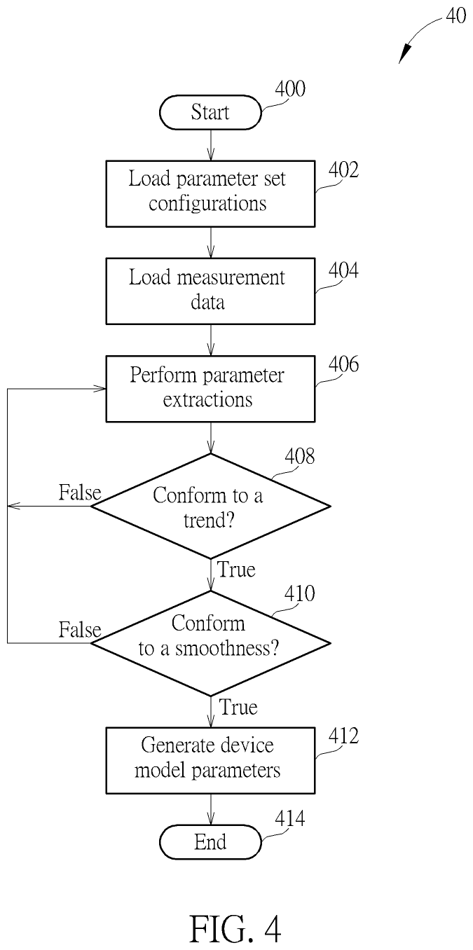

FIG. 4 is a flowchart of a process 40 according to an example of the present invention. The process 40 may be utilized in the process 30, and may include the following steps:
Step 400: Start.
Step 402: Load a plurality of parameter set configurations of a plurality of devices.
Step 404: Load a plurality of measurement data of the plurality of devices.
Step 406: Perform a plurality of parameter extractions on the plurality of parameter set configurations and the plurality of measurement data, to generate a parameter set.
Step 408: Determine whether the plurality of devices conform to a trend according to the parameter set. Go to Step 410 if the determination is true (e.g., yes), return to Step 406 if the determination is false (e.g., no).
Step 410: Determine whether the plurality of devices conform to a smoothness according to the parameter set. Go to Step 412 if the determination is true, return to Step 406 if the determination is false.
Step 412: Generate a plurality of device model parameters according to the parameter set.
Step 414: End.

In one example, the order of Step 408 and Step 410 may be exchanged.

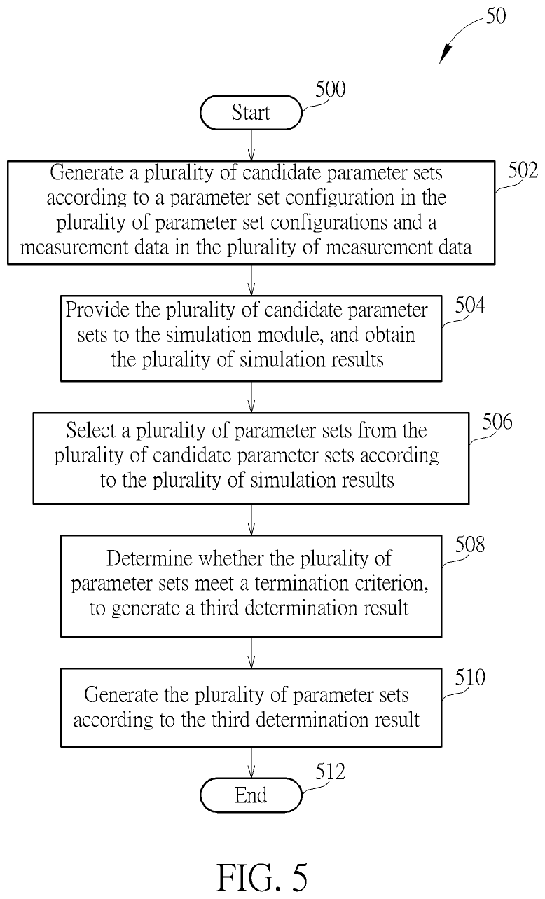

Step 304 in the abovementioned device model parameter generation system 20 may be summarized into a process 50 shown in FIG. 5. The process 50 may include the following steps:
Step 500: Start.
Step 502: Generate a plurality of candidate parameter sets according to a parameter set configuration in the plurality of parameter set configurations and a measurement data in the plurality of measurement data.
Step 504: Provide the plurality of candidate parameter sets to the simulation module (e.g., the simulation module 2100), and obtain the plurality of simulation results (e.g., from the simulation module 2100).
Step 506: Select a plurality of parameter sets from the plurality of candidate parameter sets according to the plurality of simulation results.
Step 508: Determine whether the plurality of parameter sets meet a termination criterion, to generate a third determination result.
Step 510: Generate the plurality of parameter sets according to the third determination result.
Step 512: End.

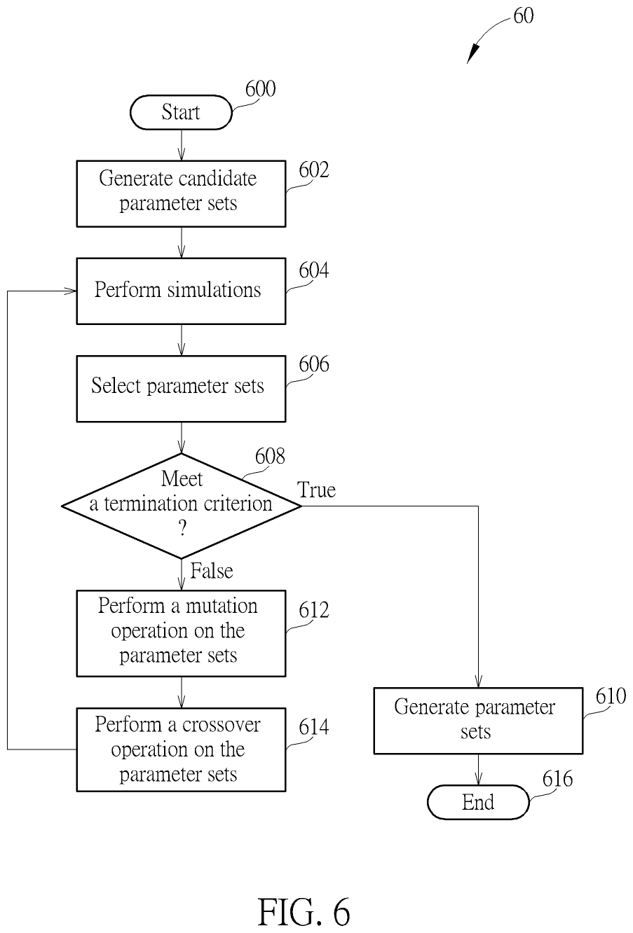

FIG. 6 is a flowchart of a process 60 according to an example of the present invention. The process 60 may be utilized in the process 50, and may include the following steps:
Step 600: Start.
Step 602: Generate a plurality of candidate parameter sets according to a parameter set configuration in the plurality of parameter set configurations and a measurement data in the plurality of measurement data.
Step 604: Perform a plurality of simulations on the plurality of candidate parameter sets, to generate a plurality of simulation results.
Step 606: Select a plurality of parameter sets from the plurality of candidate parameter sets according to the plurality of simulation results.
Step 608: Determine whether the plurality of parameter sets meet a termination criterion. Go to Step 610 if the determination is true. Go to Step 612 if the determination is false.
Step 610: Generate the plurality of parameter sets according to the plurality of parameter sets.
Step 612: Perform a mutation operation on the plurality of parameter sets.
Step 614: Perform a crossover operation on the plurality of parameter sets, and return to Step 604.
Step 616: End.

The above numbering of the terms, e.g., “first”, “second” and “third” are for distinguishing related terms, and are not for limiting the order of the related terms. The above term “determine” may be replaced by “decide”, “generate”, “obtain”, “calculate” or “compute”. The above term “according to” maybe replaced by “by using” or “via”. The above term “obtain” may be replaced by “receive”. The above term “generate” may be replaced by “calculate”, “compute” or “output”.

Those skilled in the art should readily make combinations, modifications and/or alterations on the abovementioned description and examples. The abovementioned description, systems, modules, methods, operations, devices, steps and/or processes may be realized by means that could be hardware, software, firmware (known as a combination of a hardware device and computer instructions and data that reside as read-only software on the hardware device), an electronic system, or combinations thereof. Realizations of the present invention may include the device model parameter generation system 20. The device model parameter generation system 20 (and modules therein) are various. For example, the modules mentioned above may be integrated into one or more modules.

Examples of the hardware may include analog circuit(s), digital circuit(s) and/or mixed circuit(s). For example, the hardware may include application-specific IC(s) (ASIC(s)), field programmable gate array(s) (FPGA(s)), programmable logic device(s), coupled hardware components or combinations thereof. In one example, the hardware includes general-purpose processor(s), microprocessor(s), controller(s), digital signal processor(s) (DSP(s)) or combinations thereof. In one example, the hardware includes any kind of circuit device, e.g., resistors, capacitors, inductors, transformers, transmission lines, diodes, transistor (e.g., bipolar junction transistor (BJT), junction gate field-effect transistor (JFET), Metal-Oxide-Semiconductor Field-Effect Transistor (MOSFET) or combinations thereof.

Examples of the software may include set(s) of codes, set(s) of instructions and/or set(s) of functions retained (e.g., stored) in a storage unit, e.g., a computer-readable medium. The computer-readable medium may include Subscriber Identity Module (SIM), Read-Only Memory (ROM), flash memory, Random Access Memory (RAM), CD-ROM/DVD-ROM/BD-ROM, magnetic tape, hard disk, optical data storage device, non-volatile storage unit, or combinations thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

To sum up, the present invention provides a system and a method for generating device model parameters. It not only may automatically generate the device model parameters by repeatedly and automatically performing parameter extraction operations, but also may take into account a trend and a smoothness of adjacent devices. Thus, efficiency and reliability of generating the device model parameters is improved, consistency with changes of device model parameters in the adjacent devices is further improved. These improvements may meet the needs of the field or industry. Thus, problems to be solved in the prior art can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device model parameter generation system, comprising:
a user module, for obtaining a plurality of parameter set configurations and a plurality of measurement data of a plurality of devices;
a parameter extraction module, coupled to the user module, for performing a plurality of parameter extractions on the plurality of parameter set configurations and the plurality of measurement data, to generate a parameter set;
a simulation module, coupled to the parameter extraction module, for performing a plurality of simulations according to the plurality of parameter set configurations and the plurality of measurement data, to generate a plurality of simulation results;
an analysis module, coupled to the parameter extraction module, for determining whether the plurality of devices conform to a trend according to the parameter set, to generate a first determination result, and for determining whether the plurality of devices conform to a smoothness according to the first determination result and the parameter set, to generate a second determination result; and
a device model parameter generation module, coupled to the analysis module, for generating a plurality of device model parameters according to the second determination result and the parameter set.

2. The device model parameter generation system of claim 1, wherein the operation of performing the plurality of parameter extractions on the plurality of parameter set configurations and the plurality of measurement data comprises:
(A) generating a plurality of candidate parameter sets according to a parameter set configuration in the plurality of parameter set configurations and a measurement data in the plurality of measurement data;
(B) providing the plurality of candidate parameter sets to the simulation module, and obtaining the plurality of simulation results;
(C) selecting a plurality of parameter sets from the plurality of candidate parameter sets according to the plurality of simulation results;
(D) determining whether the plurality of parameter sets meet a termination criterion, to generate a third determination result; and
(E) generating the plurality of parameter sets according to the third determination result.

3. The device model parameter generation system of claim 2, wherein the parameter extraction module generates the plurality of parameter sets according to the plurality of parameter sets, when the third determination result indicates that the plurality of parameter sets meet the termination condition.

4. The device model parameter generation system of claim 2, wherein the parameter extraction module performs a genetic algorithm on the plurality of parameter sets to generate the plurality of parameter sets and returns to the operation (B), when the third determination result indicates that the plurality of parameter sets do not meet the termination condition.

5. The device model parameter generation system of claim 4, wherein the genetic algorithm comprises a crossover operation or a mutation operation.

6. The device model parameter generation system of claim 1, wherein the analysis module determines whether the plurality of devices conform to the smoothness to generate the second determination result, when the first determination result indicates that the plurality of devices conform to the trend.

7. The device model parameter generation system of claim 6, wherein the device model parameter generation module generates the plurality of device model parameters according to the parameter set, when the second determination result indicates that the plurality of devices conform to the smoothness.

8. The device model parameter generation system of claim 6, wherein the analysis module returns to the parameter extraction module 210 and the parameter extraction module 210 performs the plurality of parameter extractions on the plurality of parameter set configurations and the plurality of measurement data, when the second determination result indicates that the plurality of devices do not conform to the smoothness.

9. The device model parameter generation system of claim 1, wherein the analysis module returns to the parameter extraction module 210 and the parameter extraction module 210 performs the plurality of parameter extractions on the plurality of parameter set configurations and the plurality of measurement data, when the first determination result indicates that the plurality of devices do not conform to the trend.

10. The device model parameter generation system of claim 1, wherein the operation of determining whether the plurality of devices conform to the trend according to the parameter set to generate the first determination result comprises:
generating a first slope according to the plurality of measurement data, and generating the trend according to the first slope;
generating a second slope according to the plurality of devices corresponding to the plurality of simulation results, and comparing the second slope with the first slope to generate a first comparison result; and
generating the first determination result according to the first comparison result.

11. The device model parameter generation system of claim 1, wherein the operation of determining whether the plurality of devices conform to the smoothness to generate the second determination result comprises:
performing an interpolation operation on the plurality of devices to generate a plurality of virtual devices, and generating a plurality of third slopes according to the plurality of virtual devices;
comparing the plurality of third slopes with the first slope to generate a plurality of second comparison results; and
determining whether the plurality of devices conform to the smoothness according to the plurality of second comparison results, to generate the second determination result.

12. A method of generating a device model parameter, comprising:
obtaining a plurality of parameter set configurations and a plurality of measurement data of a plurality of devices;
performing a plurality of parameter extractions on the plurality of parameter set configurations and the plurality of measurement data, to generate a parameter set;
performing a plurality of simulations according to the plurality of parameter set configurations and the plurality of measurement data, to generate a plurality of simulation results;
determining whether the plurality of devices conform to a trend according to the parameter set, to generate a first determination result, and for determining whether the plurality of devices conform to a smoothness according to the first determination result and the parameter set, to generate a second determination result; and
generating a plurality of device model parameters according to the second determination result and the parameter set.
